(19) United States
(12) Patent Application Publication
(10) Pub. No.: US 2004/0254508 A1
(43) Pub. Date: Dec. 16, 2004

(54) Massage bar

(76) Inventor: Chin-Tsun Lee, Yongkang City (TW)

Correspondence Address: CHIN-TSUN LEE, P.O. Box 90, Tainan City, 704, TW

(21) Appl. No.: 10/461,491

(22) Filed: Jun. 16, 2003

(51) Int. Cl. A61H 15/00

(52) U.S. Cl. 601/119; 601/120; 601/121; 601/123; 601/125

(57) ABSTRACT

A massage bar made integral includes a plurality of lengthwise rows of massage projections spaced apart equidistantly on its outer surface. Each projection is 0.5 cm-2.0 cm high, and the distance between every two neighboring projections is longer than the height of the projections. When the massage bar is placed and rolled over on a section of a human body, the rows of the massage projections only may alternately contact strikingly and press the body as if the muscle of the body pressed jumps up and down to make spot massage.

### BACKGROUND OF THE INVENTION

1. Field of the Invention

This invention relates to a massage bar, particularly to one made integral and provided with a plurality of massage projections arranged in regular rows on its outer surface. Each massage projection is 0.5 cm-2.0 cm high, and the lateral distance between every two massage projections is longer than the height of each massage projection so that the tops of the massage projections touch on the human body, with the outer surface of the massage bar not touching on the human body. Therefore, when the massage bar is placed on a portion of a human body and rolled over for massaging, the massage projections arranged in rows are moved in rotating mode to massage the human body as if the muscle of the human body where the tops of the massage projections contact and press jumps up and down to produce jumping and point pressing massage.

2. Description of the Prior Art

A common conventional massage appliance 1 shown in FIG. 1 includes two side bases 10, and two shafts 11 combined and rotate between the two side bases 10. Each shaft 11 has a plurality of lengthwise rows of projections 12 and cut grooves 13 lengthwise and laterally provided between every two projections 12 on an outer surface.

In using the conventional massage appliance 1, a user holds and places it on a section of the body, and pushes it to rotate so that the projections may contact and move on the section (such as shoulder, neck, vertebrae, back hand, leg, etc.) to be massaged. Then the projections 12 slides on the user's body to make massage. However, the projections 12 have a small dimension to contact the body of a user, not deeply pressing the muscle of the body, resulting in limited effectiveness.

### SUMMARY OF THE INVENTION

The purpose of the invention is to offer a massage bar rolled quickly on a human body to produce striking and spot pressing with small projections so as to effect enough massage to various sections of the body, revving up blood circulation, decreasing sour pain and getting rid of fatigue.

The feature of the invention is a plurality of lengthwise rows of small massage projections arranged on the surface of a massage bar and having a height 0.5 cm-2.0 cm, and the lateral distance between every two projections is longer than the height of the projections.

### BRIEF DESCRIPTION OF DRAWINGS

This invention will be better understood by referring to the accompanying drawings, wherein:

FIG. 1 is a perspective view of a conventional massage appliance;

FIG. 2 is a perspective view of a massage bar in the present invention;

FIG. 3 is a side view of the massage bar in the present invention;

FIG. 4 is a side view of the massage bar being rolled manually in the present invention;

FIG. 5 is a perspective view of a second embodiment of a massage bar in the present invention;

FIG. 6 is a perspective view of the second embodiment being used for massaging in the present invention;

FIG. 7 is a perspective view of a third embodiment of a massage bar in the present invention; and,

FIG. 8 is a fourth embodiment of a massage bar in the present invention.

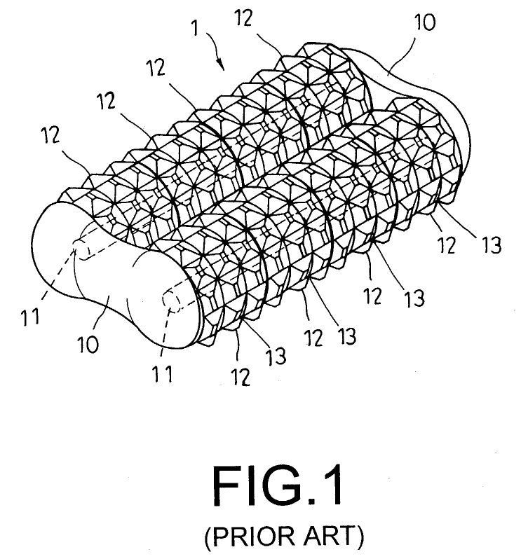

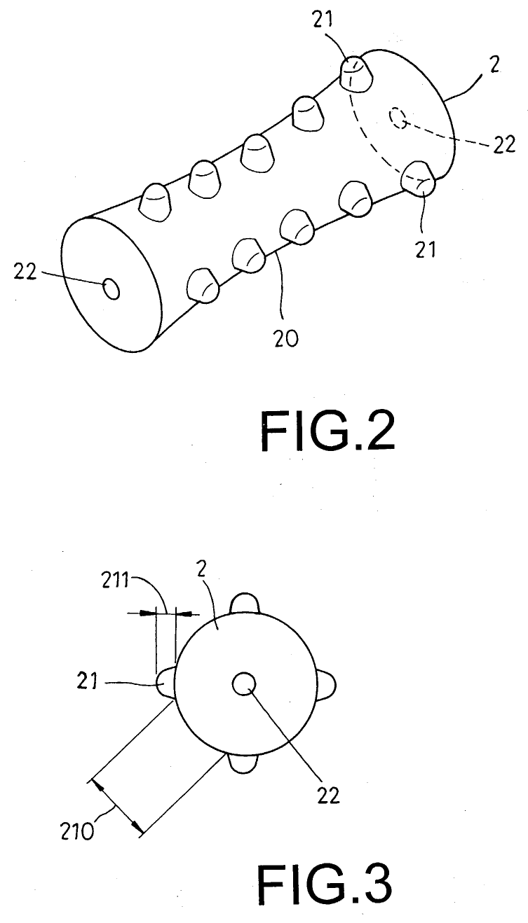

### DETAILED DESCRIPTION OF THE PREFERRED EMBODIMENT

A first embodiment of a massage bar 2 in the present invention, as shown in Fig., includes a concave surface 20, a plurality of massage projections 21 arranged in parallel rows equidistantly or crossing with each other on the concave surface, and a shaft hole 22 respectively formed in two ends. Each projection 21 is cone-shaped, having a height 211 0.5 cm-2.0 cm, with the lateral distance 210 between every two neighboring projections 21 being longer than the height 211, as shown in FIG. 3.

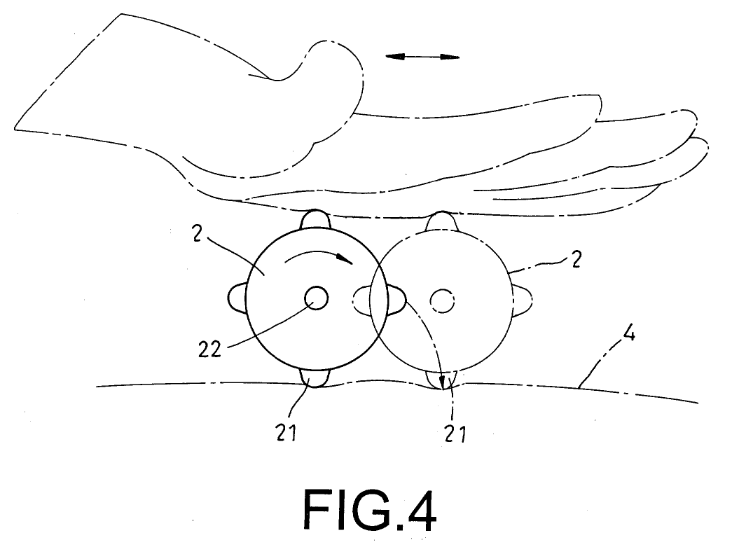

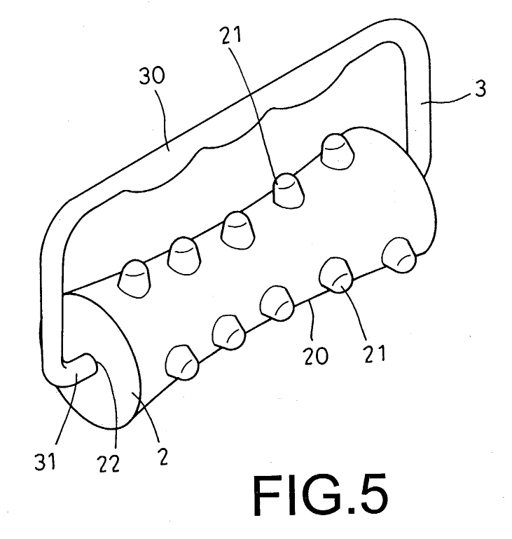

In using, as shown in FIG. 4, a user holds the massage bar 2, and places it on a section 4 (such as a shoulder, the neck, the vertebrate, the back, a hand, a leg, etc.) of a body to be massaged, with one row of the projections 21 contacting, pressed and rolled manually. Then the projections 21 may have their centers of gravity moving from the center portion to the margin and gradually separating from the massaged section 4 to let the next row of projections 21 to roll down with quickness to strike on a near location of the section 4 massaged, with the muscle of the locations being pressed down and then released. Therefore, the massage bar 2 rolls on the body with the projections 21 contacts the body to make spot pressing and jumping with pressure to produce massaging effectiveness so that the user can obtain better blood circulation, pain reducing and fatigue removing.

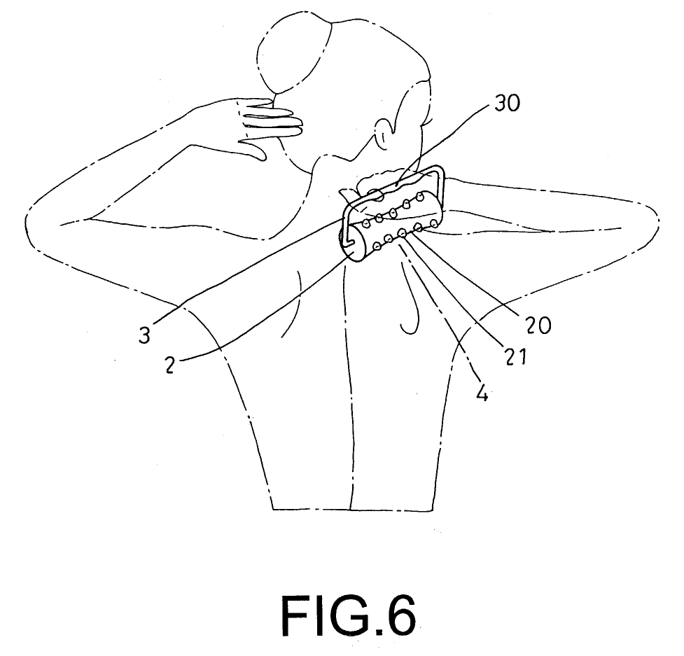

Next, a second embodiment of the invention is shown in FIG. 5, including additionally a grip 3 to the first embodiment. The grip 3 is invertedly U-shaped, consisting of a gripping member 30 and two pivot ends 31 fitting in the shaft holes 22 of the massage bar 2. Then in using, as shown in FIG. 6, a user holds the grip 3 and places on the section 4 to be massaged of the body (such as a shoulder, the neck, the vertebrae, the back, a hand, or a leg, etc.), and rolls the massage bar 2 on the portion 4.

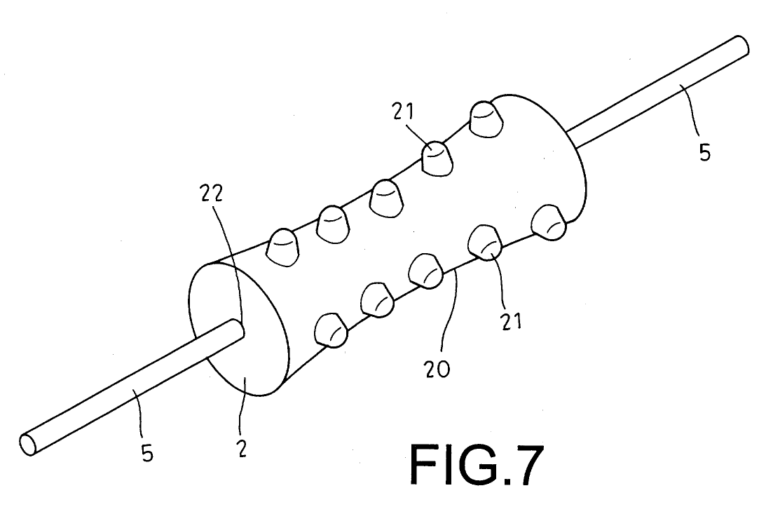

A third embodiment of the invention is shown in FIG. 7, including additionally an elongate grip 5 extending through the center shaft hole 22 of the massage bar 2 in the first embodiment and protruding out of the two ends of the massage bar 2 for a hand or two hands to grip for rolling so as to perform massage on the body.

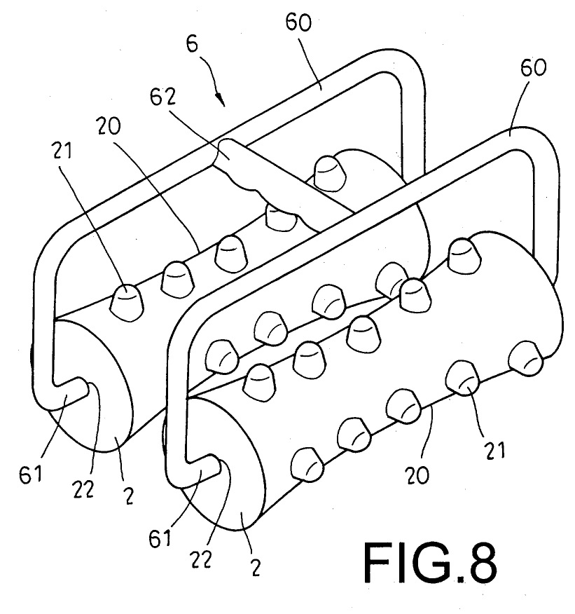

Further, a fourth embodiment of the invention is shown in FIG. 8, including at least two massage bars 2 in the first embodiment, a grip unit 6 consisting of two connect rods 60 of an inverted U-shape respectively with two bent ends to fit in the shaft holes 22 of the massage bar 2 and a grip 62 connected between the center portion of the two connect rods 60. Then a user can hold the grip 62 for rolling the two massage bars 2 to perform massage on a human body.

While the preferred embodiments of the invention have been described above, it will be recognized and understood that various modifications may be made therein and the appended claims are intended to cover all such modifications that may fall within the spirit and scope of the invention.

What is claimed is:

1. A massage bar made integral, having a plurality of small massage projections on an outer surface, said projections arranged to be located in lengthwise rows equidistantly spaced apart, each said massage projection having a height 0.5 cm-2.0 cm, with a distance between every two of said projections in every two rows being longer than the height of each said projections so as to make said massage projections contact a human body with small spots; a first row of said massage projections having their center of gravity moving from the center to the margin when said row of said massage bar is placed and rolled on the body of a user, a second row of said massage projections quickly rolled to strike a neighboring section of said body just pressed by the first row so that all rows of the said massage projections may perform massage function as if the muscle of the body contacted and pressed by said massage projections jumps up and down to acquire massage.

2. The massage bar as claimed in claim 1, wherein said massage bar has a shaft hole respectively in two end surfaces, and an inverted U-shaped grip is additionally provided, having two bent ends pivotally fitting in the two shaft holes of said massage bar to permit said massage bar rotate with said two bent ends functioning as pivots.

3. The massage bar as claimed in claim 2, wherein an elongate rod is provided to extend in a center hole of said massage bar instead of said inverted U-shaped grip.

4. The massage bar as claimed in claim 1, wherein at least two said massage bars are provided side by side, and a grip unit is provided to hold said two massage bars together.

5. The massage bar as claimed in claim 1, wherein each said massage projection is shaped as conical.

6. The massage bar as claimed in claim 1, wherein said massage bar has a concave surface.
